(19) United States
(12) Patent Application Publication
(10) Pub. No.: US 2013/0040171 A1
(43) Pub. Date: Feb. 14, 2013

(54) ENERGY STORAGE DEVICE AND ASSOCIATED METHOD

(71) Applicant: Robert Christie Galloway, Derbyshire (GB)

(72) Inventor: Robert Christie Galloway, Derbyshire (GB)

(21) Appl. No.: 13/207,769

(22) Filed: Aug. 11, 2011

(51) Int. Cl. H01M 10/39

(52) U.S. Cl. 429/51; 429/103

(57) ABSTRACT

An energy storage device is provided that includes a reservoir in operative communication with a positive electrode such that the positive electrode remains fully flooded, even at the top of the charge cycle. The device more particularly includes a housing receiving therein, in a coaxial manner, an ion conducting member, and a current collector member received coaxially within the ion conducting member. In this device, a first region is provided in the space between the housing and the ion conducting member and a second region is provided in the space between the ion conducting member and the current collector member. The interior of the current collector member defines a reservoir having a certain volume at least equal to the volume of the void space created in the second region during charging of the device.

### BACKGROUND OF THE DISCLOSURE

1. Technical Field

The invention includes embodiments that relate to an energy storage device. More particularly, the invention includes embodiments that relate to an energy storage device wherein the positive electrode is fully flooded even at the top of charge.

2. Discussion of Art

Metal chloride batteries with molten sodium anode and beta-alumina solid electrolyte are employed for energy storage applications. The energy storage application may include mobile applications due to the metal chloride battery's high energy density and long cycle life. Such energy storage devices include a sodium negative (anode) electrode separated from the positive (cathode) electrode by a sodium ion conducting ceramic beta-alumina structure or material. A secondary electrolyte, for example molten salt sodium tetrachloro aluminate, is present in the positive electrode to transmit sodium ions between the reaction sites in the positive electrode and the beta-alumina. The conventional cell design may include a tube of beta-alumina with the positive electrode disposed within the tube.

In conventional cell designs the beta-alumina tube is filled to near the top of the tube with positive electrode material. During the charge process the negative electrode is filled with a mass of sodium flowing from the cathode, and a space or volume is created in the positive electrode corresponding to the loss of mass. This may result in the positive electrode being less than fully flooded at the top of charge. The result may be less than optimum performance parameters for certain cell characteristics. Therefore, it may be desirable to have an energy cell design that differs from those designs that are currently available.

### SUMMARY OF THE DISCLOSURE

In accordance with one aspect of the invention, an energy storage device is provided that includes a reservoir in operative communication with a positive electrode such that the positive electrode remains fully flooded, even at the top of the charge cycle. The device more particularly includes a housing having an inward facing surface defining a first region; an ion-conducting member disposed within the first region, and having an inward facing surface defining a second region disposed within the first region; and a reservoir region that is a portion of the second region and is in operative communication with the remaining portion of the second region. The energy storage device has a plurality of operating states, and in a fully discharged operating state the reservoir region defines a volume at least equal to the volume of void space in the second region when the device is in a fully charged operating state.

In one embodiment, the device comprises a cathode, an anode, and a reservoir, the cathode and anode being separated by an ion conducting separator, and the cathode and reservoir being separated by a current collector, and further, in the discharged state, the cathode containing active electrode material including a transition metal halide, an alkali metal electrolyte, and an alkali metal-aluminum-halide molten salt electrolyte, and the reservoir containing the same molten salt electrolyte.

In accordance with one embodiment, the ion conducting member is a separator, for example a beta-alumina separator, capable of providing a path for ion transfer between the first region and the second region, and a current collector, for example a hollow nickel tube, disposed within the second region defines the reservoir region. In one embodiment, the housing receives the ion conducting member concentrically and coaxially, and the ion conducting member receives the current collector concentrically and coaxially. In another embodiment, at least one of the housing, ion conducting member and current collector are cylindrical, and in some embodiments, they are each cylindrical, providing a circular cross-section. In another embodiment, the current collector has continuous walls, i.e. without pores or other voids, and is sealed at an upper end.

In one embodiment, an energy storage device is provided, the device including a central reservoir comprising in concentric and coaxial relation from the exterior to the interior: a housing; a beta-alumina tube disposed within the housing such that a first region is present between the housing and the beta-alumina tube; a hollow nickel tube disposed within the beta-alumina tube such that a second region is present between the beta-alumina tube and the hollow nickel tube; and a third region present within the hollow nickel tube defining a central reservoir in operative communication with the second region. The beta-alumina tube may have a diameter in a range of from about 30 millimeters to about 65 millimeters, an axial length in a range of from about 200 millimeters to about 500 millimeters, and a volume of about 140 cubic centimeters to 1658 cubic centimeters, and the hollow nickel tube may have a diameter of about 10 millimeters to about 35 millimeters, an axial length of about 200 millimeters to about 500 millimeters, and a volume of about 16 cubic centimeters to about 480 cubic centimeters. In one embodiment, the second region may have a width of about 13 millimeters.

In certain embodiments, the current collector may prevent entry of material contained in the second region into the reservoir. The reservoir is, however, in communication with the second region such that, in response to a depletion of material contained in the second region during charging, material from the reservoir preferentially wicks into the second region. In this manner, the second region maintains a fully flooded state during operation due to the wicking of material from the reservoir into the second region.

In some embodiments, the reservoir region contains molten salt electrolyte and the plurality of operating states includes operating states that are partially charged, and at a given operating state the reservoir region is correspondingly partially full with molten salt electrolyte.

In one embodiment, the reservoir region contains a porous membrane material, such porous membrane either being disposed as a bisecting membrane within the current collector or as radial fins arranged around the longitudinal axis of the current collector.

In accordance with an aspect of the invention, an energy storage device is provided wherein the device includes a housing having disposed therein in a concentric and coaxial manner a beta-alumina separator tube, and wherein a hollow nickel current collector tube is disposed concentrically and coaxially within the beta-alumina tube, the hollow nickel tube defining a reservoir and being in operative communication with a positive electrode located in the region between the beta-alumina tube and the hollow nickel tube.

In accordance with an aspect of the invention, a method is provided for maintaining a fully flooded positive electrode during operation of an energy storage device, the method comprising: providing a device having a first outermost region proximate a negative electrode, a central reservoir region, and a second region disposed intermediate the first region and the reservoir region and proximate a positive electrode; flowing ionic mass from the second region to the first region, thereby creating a void space in the second region, and flowing molten salt from the reservoir region into the second region in response to the creation of the void space, thereby maintaining a fully flooded positive electrode during operation of the energy storage device.

In one embodiment, the method further includes flowing ionic mass from the first region to the second region. In another embodiment molten salt flows from the reservoir region to the second region, the molten salt comprising sodium chloroaluminate.

In accordance with an aspect of the invention, an energy storage device having a central reservoir is provided, the device including: a housing; a beta-alumina tube concentrically and coaxially disposed within the housing such that a first region is present between the housing and the beta-alumina tube, the beta-alumina tube having a diameter of about 60 millimeters and an axial length of about 300 millimeters; a hollow nickel tube concentrically and coaxially disposed within the beta-alumina tube, such that a second region is present between the beta-alumina tube and the hollow nickel tube, and a third region present within the hollow nickel tube defining a reservoir, the hollow nickel tube having a diameter of about 30 millimeters and an axial length of about 270 millimeters; an active electrode material impregnated with molten salt disposed in the second region, this second region having a radial width of about 13 millimeters; and having molten salt further disposed in the reservoir, the reservoir being in operative communication with the second region.

### BRIEF DESCRIPTION OF THE DRAWINGS

These and other features and aspects of the invention will become better understood with reference to the accompanying drawings in which like characters represent like parts, and wherein:

FIG. 1 is a cross-sectional view along the axial length of an energy storage device in accord with an embodiment of the invention.

FIG. 2 is a cross-sectional view of the device along line A-A of FIG. 1.

FIGS. 3A-3C are cross-sectional views of an energy storage device at various stages of charge in accord with an embodiment of the invention.

FIGS. 4A-4B are cross-sectional views of the hollow nickel tube current collector in accord with an embodiment of the invention.

FIG. 5 is a graph comparing charge performance of a conventional cell as compared to a cell in accord with the invention.

FIG. 6 is a graph comparing discharge performance of a conventional cell as compared to a cell in accord with the invention.

FIG. 7 is a graph comparing discharge performance of a conventional cell as compared to a cell in accord with the invention.

FIG. 8 is a graph comparing charge time as a function of amp hours for a conventional cell as compared to a cell in accord with the invention.

### DETAILED DESCRIPTION

The invention includes embodiments related to a novel energy storage device. Some embodiments relate to an energy storage device having a central reservoir, in operative communication with the positive electrode of the device and containing molten salt that wicks into the positive electrode during charging of the device to maintain the positive electrode in the fully flooded state. The invention includes embodiments relating to methods of using and of making the energy storage device.

As used herein, “device” and “cell” may be used interchangeably. The term “reservoir” is used herein to refer to the region within the current collector, which in some embodiments is a hollow nickel tube, a porous membrane, or a combination thereof. The terms “annulus” and “second region” may be used interchangeably to refer to the radial space between the separator/beta-alumina tube and the current collector/hollow nickel tube. “Active electrode material” and “positive electrode material” may be used interchangeably to refer to the material disposed in the second region. “Region” is used herein to define an area within the device in accord with the stated relationship of various members of the device. “Fully flooded” is used herein to refer to a state wherein a region containing a material is full or substantially full relative to its maximum capacity. “Operative communication” means that material disposed in one region may transgress into another region.

In accordance with one aspect of the invention, an energy storage device is provided that includes a reservoir in operative communication with a positive electrode such that the positive electrode remains fully flooded, even at the top of the charge cycle, and even after multiple charge/discharge cycles. The device more particularly includes a housing having an inward facing surface defining a first region; an ion-conducting member disposed within the first region, and having an inward facing surface defining a second region disposed within the first region; and a reservoir region that is a portion of the second region and is in operative communication with the remaining portion of the second region. The energy storage device has a plurality of operating states, and in a fully discharged operating state the reservoir region defines a volume at least equal to the volume of void space in the second region when the device is in a fully charged operating state.

In one embodiment, the device comprises a cathode, an anode, and a reservoir, the cathode and anode being separated by an ion conducting separator, and the cathode and reservoir being separated by a current collector, and further, in the discharged state, the cathode containing active electrode material including a transition metal halide, an alkali metal electrolyte, and an alkali metal-aluminum-halide molten salt electrolyte, and the reservoir containing the same molten salt electrolyte.

In accordance with one embodiment, the ion conducting member is a separator, for example a beta-alumina separator, capable of providing a path for ion transfer between the first region and the second region, and a current collector, for example a hollow nickel tube, disposed within the second region defines the reservoir region. In one embodiment, the housing receives the ion conducting member concentrically and coaxially, and the ion conducting member receives the current collector concentrically and coaxially. In another embodiment, at least one of the housing, ion conducting member and current collector are cylindrical, and in some embodiments, they are each cylindrical, providing a circular cross-section. In another embodiment, the current collector has continuous walls, i.e. without pores or other voids, and is sealed at an upper end.

In one embodiment, an energy storage device is provided, the device including a central reservoir comprising in concentric and coaxial relation from the exterior to the interior: a housing; a beta-alumina tube disposed within the housing such that a first region is present between the housing and the beta-alumina tube; a hollow nickel tube disposed within the beta-alumina tube such that a second region is present between the beta-alumina tube and the hollow nickel tube; and a third region present within the hollow nickel tube defining a central reservoir in operative communication with the second region. The beta-alumina tube may have a diameter in a range of from about 30 millimeters to about 65 millimeters, an axial length in a range of from about 200 millimeters to about 500 millimeters, and a volume of about 140 cubic centimeters to 1658 cubic centimeters, and the hollow nickel tube may have a diameter of about 10 millimeters to about 35 millimeters, an axial length of about 200 millimeters to about 500 millimeters, and a volume of about 16 cubic centimeters to about 480 cubic centimeters. In one embodiment, the second region may have a width of about 13 millimeters.

In certain embodiments, the current collector may prevent entry of material contained in the second region into the reservoir. The reservoir is, however, in communication with the second region such that, in response to a depletion of material contained in the second region during charging, material from the reservoir preferentially wicks into the second region. In this manner, the second region maintains a fully flooded state during operation due to the wicking of material from the reservoir into the second region.

In some embodiments, the reservoir region contains molten salt electrolyte and the plurality of operating states includes operating states that are partially charged, and at a given operating state the reservoir region is correspondingly partially full with molten salt electrolyte.

In one embodiment, the reservoir region contains a porous membrane material, such porous membrane either being disposed as a bisecting membrane within the current collector or as radial fins arranged around the longitudinal axis of the current collector.

In accordance with an aspect of the invention, an energy storage device is provided wherein the device includes a housing having disposed therein in a concentric and coaxial manner a beta-alumina separator tube, and wherein a hollow nickel current collector tube is disposed concentrically and coaxially within the beta-alumina tube, the hollow nickel tube defining a reservoir and being in operative communication with a positive electrode located in the region between the beta-alumina tube and the hollow nickel tube.

In accordance with an aspect of the invention, a method is provided for maintaining a fully flooded positive electrode during operation of an energy storage device, the method comprising: providing a device having a first outermost region proximate a negative electrode, a central reservoir region, and a second region disposed intermediate the first region and the reservoir region and proximate a positive electrode; flowing ionic mass from the second region to the first region, thereby creating a void space in the second region, and flowing molten salt from the reservoir region into the second region in response to the creation of the void space, thereby maintaining a fully flooded positive electrode during operation of the energy storage device.

In one embodiment, the method further includes flowing ionic mass from the first region to the second region. In another embodiment molten salt flows from the reservoir region to the second region, the molten salt comprising sodium chloroaluminate.

In accordance with still another aspect of the invention, an energy storage device having a central reservoir is provided, the device including: a housing; a beta-alumina tube concentrically and coaxially disposed within the housing such that a first region is present between the housing and the beta-alumina tube, the beta-alumina tube having a diameter of about 60 millimeters and an axial length of about 300 millimeters; a hollow nickel tube concentrically and coaxially disposed within the beta-alumina tube, such that a second region is present between the beta-alumina tube and the hollow nickel tube, and a third region present within the hollow nickel tube defining a reservoir, the hollow nickel tube having a diameter of about 30 millimeters and an axial length of about 270 millimeters; and an active electrode material impregnated with molten salt disposed in the second region, this second region having a width of about 13 millimeters, and the molten salt disposed in the reservoir in operative communication with the second region.

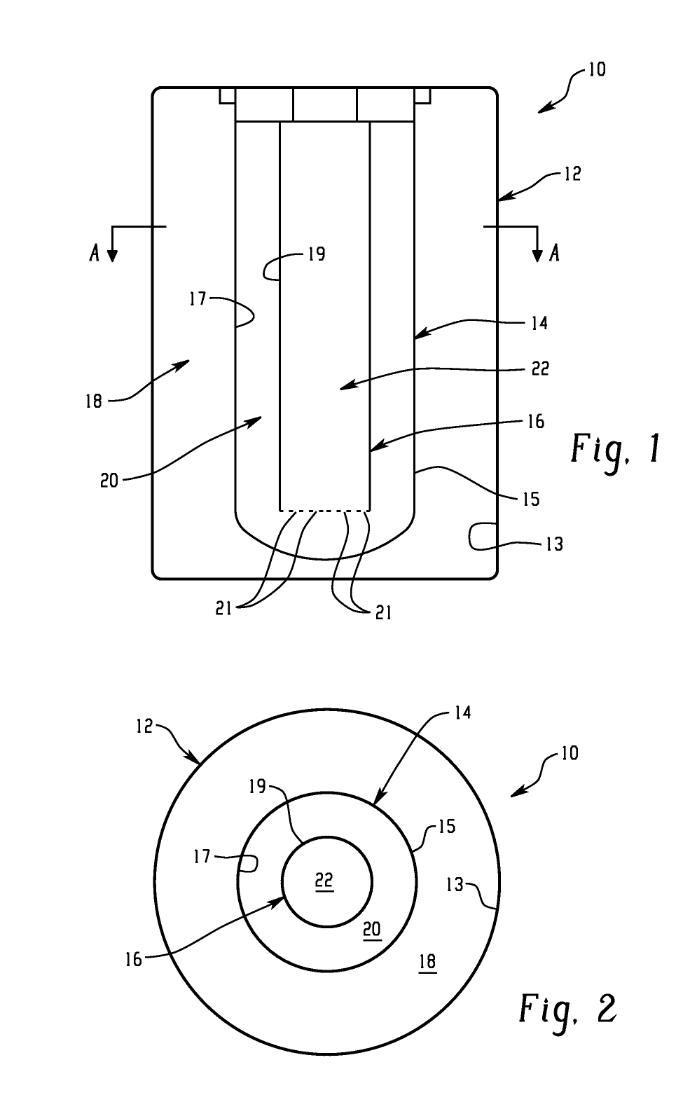

In one embodiment, the design includes an energy storage cell or device including an anode, a cathode, a solid separator, and a reservoir. With reference to FIG. 1, there is provided a cross-sectional view along the length of an energy storage device 10 in accord with an embodiment of the invention. The device 10 includes housing 12 having an interior surface defining a volume. Housing 12 has a cylindrical shape. A separator 14 is disposed concentrically and coaxially in the housing, as better seen with reference to FIG. 2, which provides a cross-sectional view of the device along line A-A of FIG. 1. The separator 14, which provides a path for ion transfer between the cathode/positive electrode/second region and anode/negative electrode/first region, comprises a cylindrical tube having a diameter less than that of housing 12 and having an outer surface 5 that defines at least a portion of first region 18, which is further defined by the interior surface 13 of housing 12. Current collector/hollow nickel tube 16 is disposed concentrically and coaxially within separator 14. The annular space between an outer surface 19 of hollow nickel tube 16 and the inner surface 17 of separator 14 defines second region 20. The hollow interior region of tube 16 defines reservoir 22, which is in operative communication with second region 20, through opening or path 21.

Though the energy storage device may be cylindrical in shape, having a circular cross-section normal to the axial direction of the cylinder, the device may not be limited to this particular geometry. Rather, so long as a device includes those members defined above, and the relationship between various members and regions as a whole retain substantially the same capability to provide a fully flooded positive electrode at the top of charge, such device comes within the purview of the invention. Further, while various members and regions are recited, with respect to FIGS. 1 and 2, to be concentric and coaxial, they may also function fully if they are merely coaxial and not concentric.

In one embodiment, the energy storage device in accord with an embodiment of the invention has a diameter larger than conventional energy storage devices of this type. For example, a comparable, conventional energy storage device with similar charge capacity may have a diameter of 62 millimeters and a length of 300 millimeters, defining a volume of 905 cubic centimeters. The current energy storage device, however, is larger, having a diameter of about 70 millimeters and a length of about 300 millimeters, defining a volume of about 1154 cubic centimeters. Within the housing 12 of storage device 10 in accord herewith, disposed in coaxial manner, are separator 14 and hollow nickel tube 16. Separator 14 may have a diameter of from about 30 millimeters to about 65 millimeters, for example having an inner diameter of about 57 millimeters and an outer diameter of about 60 millimeters, and a length of from about 200 millimeters to about 500 millimeters, for example about 300 millimeters, defining a volume of from about 140 cubic centimeters to about 1658 cubic centimeters, for example about 730 cubic centimeters. Hollow nickel tube 16 may have a diameter of from about 10 millimeters to about 35 millimeters, for example having an outer diameter of about 30 millimeters, and a length of from about 200 millimeters to about 500 millimeters, for example about 270 millimeters, defining a volume of from about 16 cubic centimeters to about 480 cubic centimeters, for example about 175 cubic centimeters.

The energy storage device includes a separator, also referred to herein as an ion conductor. The ions may be alkali metal ions. Suitable alkali metals include, e.g., sodium. The separator is capable of conducting ions at operational conditions. Suitable separators may be formed from beta double prime alumina. The ion conductor, disposed within the housing, provides a pathway for the transfer of ions between the cathode/second region and anode/first region of the device during charge/discharge cycle(s). The device or cell further includes a hollow metal collector tube, disposed within the separator, possibly in one or both of a concentric and a coaxial manner. The hollow interior region of the metal collector tube defines a reservoir.

Positive or active electrode material, i.e. a cathode, is disposed between the interior wall 17 of the separator 14 and the exterior wall 19 of the hollow metal collector tube 16, in the annular or second region 20. The positive electrode material is a solid, electronically conductive or active porous or particulate material, and may include a transition metal halide, TX, wherein T is a transition metal, for example Ni, Fe, Cr, Co, Mn, Cu, and mixtures of two or more thereof, and X is a halide, for example Cl, Br, or I. In addition, a secondary electrolyte is included in the positive electrode region, for example a molten salt liquid electrolyte having the formula MAlX, wherein M is an alkali metal as defined above and consistent with that present in the electrode, Al is aluminum, and X is the same halide contained in the active electrode material, and is present in the positive electrode to transmit sodium ions between the reaction sites in the positive electrode and the ion conducting beta-alumina separator. Note that no specific chemical stoichiometry is intended by the use of “TX” or “MAlX”. The person of ordinary skill would understand the stoichiometry of the formulae based on the context; e.g., choice of transition metal T and its oxidation state. Generally, the secondary electrolyte is included in an amount such that the level of secondary electrolyte in the second region is at least equal to the level of solid electrode material disposed within the second region, i.e. the upper most surface of the secondary electrolyte material is at least at a level consistent with the upper most surface of the solid electrolyte material.

In one embodiment, the device or cell includes a sodium negative electrode separated from the positive electrode by a sodium ion conducting ceramic beta-alumina separator. In this embodiment, the positive electrode may include a transition metal halide, TX, of NiCl₂. In this embodiment, T is Ni, X is Cl, and M is Na, such that the active electrode material is NiCl₂, and the molten salt liquid electrolyte is NaAlCl₄.

When used in a conventional single tube design, the beta-alumina tube is filled with positive electrode material to near the top of the beta-alumina tube, and then the cell is fully impregnated with molten salt electrolyte before sealing of the positive electrode by welding. As previously stated, the term “fully impregnated”, which may be used interchangeably herein with “fully flooded”, refers to the device region being full of material relative to its maximum capacity. In this instance, the second region is fully impregnated or flooded when the level of molten salt electrolyte in the region is at least the same as or above the level of solid electrode material disposed within the second region. Using the electrode materials as just defined, as the cell is charged, sodium is formed in the first region defining the negative electrode chamber and the volume of solids in the positive electrode chamber decreases as nickel and sodium chloride are converted to nickel chloride. The following equation represents the charge/discharge reaction that takes place between the electrodes:

Ni+2NaCl [symbol] NiCl₂+2Na

In the foregoing, the charge cycle involves the reaction from left to right and the discharge reaction is the reverse reaction going from right to left. In the charge reaction, each Ah of charge generates 0.45 cm³ of space in the positive electrode as the NiCl₂ created in the charge cycle has a smaller volume than the two reactants, Ni and NaCl, and as Na ions are conducted to the negative electrode chamber by the separator to form the sodium anode. In a conventional device, due to the reduction in positive electrode material, at the top of charge the positive electrode is not fully flooded. This may diminish certain cell characteristics, such as charging. Table I below illustrates the creation of space in the positive electrode during charging:

TABLE I
Ni + 2NaCl → NiCl₂

| Ni | | 2NaCl | | NiCl₂ | | |
|---|---|---|---|---|---|---|
| 58.71 | g | 2 × 58.44 | g | 129.6 | g | 2 × 96500 Coulombs |
| | | | | | | (53.6 Ah) |
| 6.56 | cm³ | 53.99 | cm³ | 36.5 | cm³ | |
| 0.122 | cm³ | 1.0073 | cm³ | 0.681 | cm³ | 1 Ah |

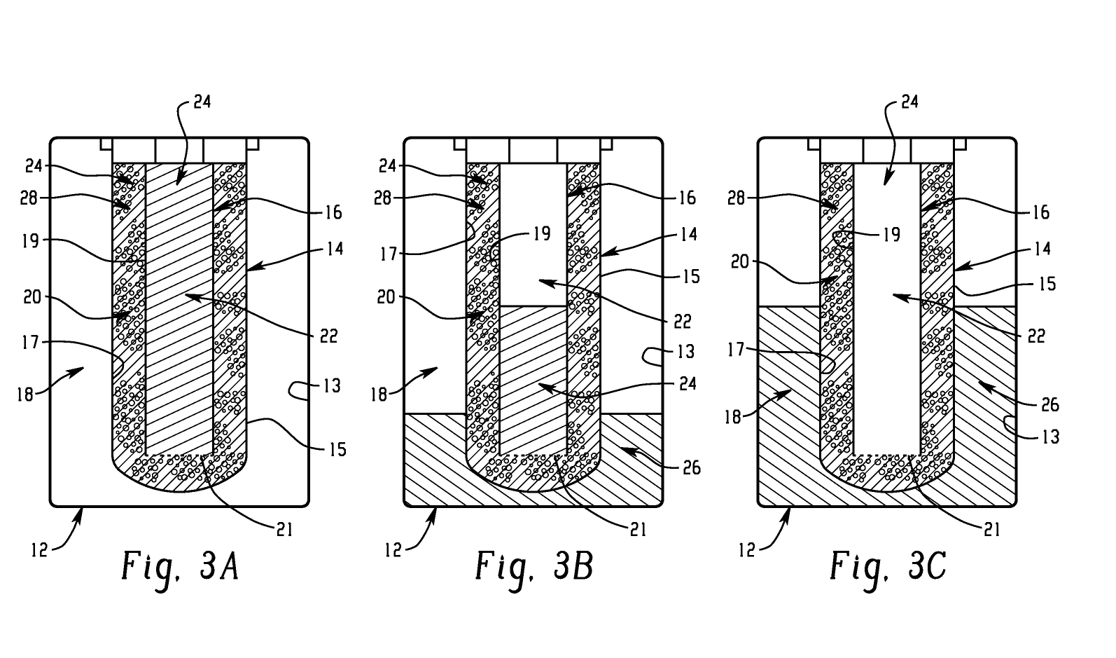

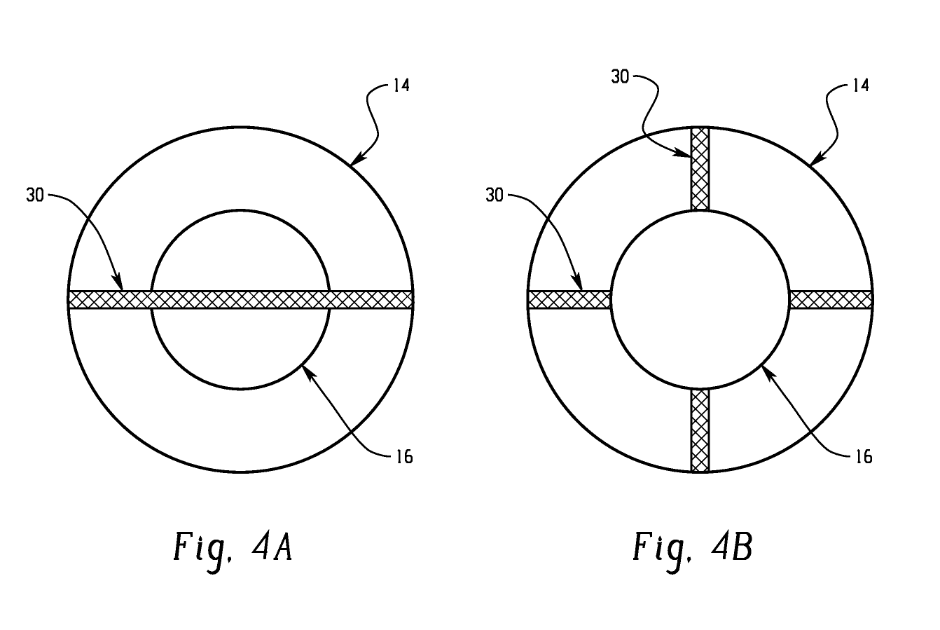

In the current design, however, an additional reservoir of molten salt liquid electrolyte replenishes the cathode. In order for the cell to provide optimum energy storage and delivery, it is desirable for active electrode material to be in operative contact with all available ion conductive sites of the separator at all times. With the current design, the cathode maintains a flooded, or fully flooded, state throughout the life of the device, optimizing the ion conducting capability of the device, and consequently device performance. With reference to FIG. 3A-C, at the bottom of discharge shown in FIG. 3A, reservoir region 22 is fully flooded with molten salt electrolyte 24. For example, in one embodiment, hollow nickel current collector may be a 20 mm diameter tube containing 95 cm³ of molten salt electrolyte. As shown in FIG. 3B, corresponding to the device in a partially charged state, the molten salt electrolyte 24 from the reservoir region 22 flows into the cathode filling the space created during the charge cycle as Na ions are conducted or transported into the first region to form the anode 26, and the molten salt electrolyte 24 level in the reservoir region falls. For example, in a partially charged state, i.e. 50% charged, the device charge is 105 Ah and the reservoir region 22 now contains only 47 cm³ of molten salt electrolyte 24. The flow may be accomplished by gravity, by diffusion, by suction, by pressure, by wicking, pumping, or by another fluid transport mechanism. In one embodiment, the flow is created by wicking At the top of charge, shown in FIG. 3C, the reservoir has little or no molten electrolyte left. For example, at the top of charge the device may have 211 Ah charge, and the reservoir is empty. Throughout the charge cycle, the second region or cathode 20 remains fully flooded with active electrode material 28 and molten salt electrolyte 24, though as the charge cycle or discharge cycle proceeds to completion, the amount of molten salt electrolyte varies according to the void space created or filled by sodium ion transfer between the cathode and anode regions, 18, 20. Conversely, during discharge, as the reaction is reversed and material moves back into the positive electrode, excess molten salt electrolyte that wicked into the positive electrode chamber during the charge cycle to maintain the chamber in a fully flooded state moves back into the reservoir, but only to the extent necessary to maintain a level of molten salt electrolyte equivalent to or greater than the level of solid electrode material in the chamber, i.e. to maintain a fully flooded state.

Without the additional liquid electrolyte from the reservoir to compensate for the normal loss of material from the cathode during charging, the electrode will experience a deficiency in the amount of molten salt at the start of discharge and will operate less efficiently. While it may be possible to provide increased electrolyte by initially filling the second region with less positive electrode and adding enough molten salt to compensate for the loss of positive electrode material, the reduction in the area of available electrode material would cause diminished performance of the cell, leading to reduced power. Structuring the positive electrode to include an additional reservoir of molten salt liquid electrolyte to supplement the electrolyte already in the positive electrode, however, ensures that the positive electrode is fully flooded, even at the top of charge, where conventional devices experience diminished performance.

In one embodiment, the flooded state of the electrode can be maintained by using a large porous membrane along the length of the electrode with sufficient free volume to contain the required amount of excess molten salt needed to fill the voids created during the charge process.

In one embodiment, a reservoir is created within the cathode using a hollow tube. The tube may be sealed at the top and open at the bottom, and placed coaxially in the middle of the beta-alumina tube. If the electrode is a nickel/nickel chloride electrode, a suitable tube may be fabricated from a non-reacting metal. Suitable non-reacting metals may include borosilicate glass or a metallic nickel sheet.

In one embodiment, a combination of the foregoing alternatives is employed. With reference to FIGS. 4A and 4B, a porous membrane 30 may bisect a split metal tube, as shown in FIG. 4A, or multiple porous membrane fins 30 may be arranged symmetrically around the outside of the metal tube reservoir and extending to the inside of the beta alumina tube, as shown in FIG. 4B. The excess molten salt would then be contained within the porous membrane or membranes, and also inside the hollow metal tube. The ionic mass may wick preferentially into the positive electrode during the charge process.

The design alternatives disclosed each include the feature of the positive electrode being in contact with the full area of the beta-alumina conductor tube, i.e. as the cell charges, the molten salt contained in the reservoir moves into the positive electrode to fill space created during the charge process ensuring continuous contact of active electrode material with substantially all available ion conducting sites of the separator. The cell performance function derived from the additional molten salt reservoir is illustrated in the following examples.

Unless specified otherwise, equipment and ingredients referred to herein throughout the specification and claims may be commercially available from such common chemical suppliers as Sigma Aldrich, Inc. (St. Louis, Mo.), Alfa Aesar, Inc. (Ward Hill, Mass.), and/or Fisher Scientific International, Inc. (Hanover Park, Ill.).

### Cell Preparation and Comparison.

### EXAMPLE 1

A Reference Cell (A) was prepared and contained 248 grams of cathodic (positive electrode) material impregnated with 115 grams of molten salt on assembly so that the level of the molten salt is above the level of the solid positive electrode material. The positive electrode is contained within a beta alumina tube with a central nickel current collector fitted with a thin porous membrane along its length. This assembly is contained within a steel cell case so that the space between the assembly and the inside of the cell case is the sodium electrode or anode.

A Test Cell (B) in accord with an embodiment of the invention was also prepared. Cell B was prepared in the same manner and using the same components as Cell A, with the exceptions as noted here. The Test Cell B was fitted with a larger porous membrane spacer and filled to the same electrode height with 230 grams of electrode material and 130 grams of molten salt, the excess amount of molten salt over that used in Reference Cell A being incorporated in the porous reservoir. Test Cell B was in all other regards the same in physical dimension and configuration as Reference Cell A.

TABLE II

| | wt. of | | | vol. of 95% | excess vol. of |
|---|---|---|---|---|---|
| | active | charge | free space | porous | molten salt in |
| Cell | material | (Ah) | created | membrane | membrane |
| Reference | 248 g. | 40.1 | 18.05 cm³ | 11 cm³ | 10.45 cm³ |
| A | | | | | |
| Test B | 230 g. | 37.2 | 16.7 cm³ | 22 cm³ | 20.9 cm³ |

At full charge, which for Reference Cell A is 40.1 Ah, 18.05 cm³ free space has been created within the positive electrode while excess molten salt within the porous membrane amounts to only 10.45 cm³, leaving a shortfall of 7.6 cm³ space left void. Hence some of the electrode will be molten salt-deficient. For Test Cell B, however, while 16.7 cm³ of free space has been created at the top of charge the excess molten salt contained within the porous membrane is 20.9 cm³, which leaves a surplus after the molten salt in the membrane has preferentially wicked into the spaces in the positive electrode.

Cell performance for cells A and B was judged by testing each type of cell in a module having 10 identical cells connected in series, i.e. Module A containing 10 Reference Cells of type A connected in series and Module B containing 10 Test Cells of type B connected in series. Each Module, A and B, was charged 10 A to 2.67 V to 0.5 A.

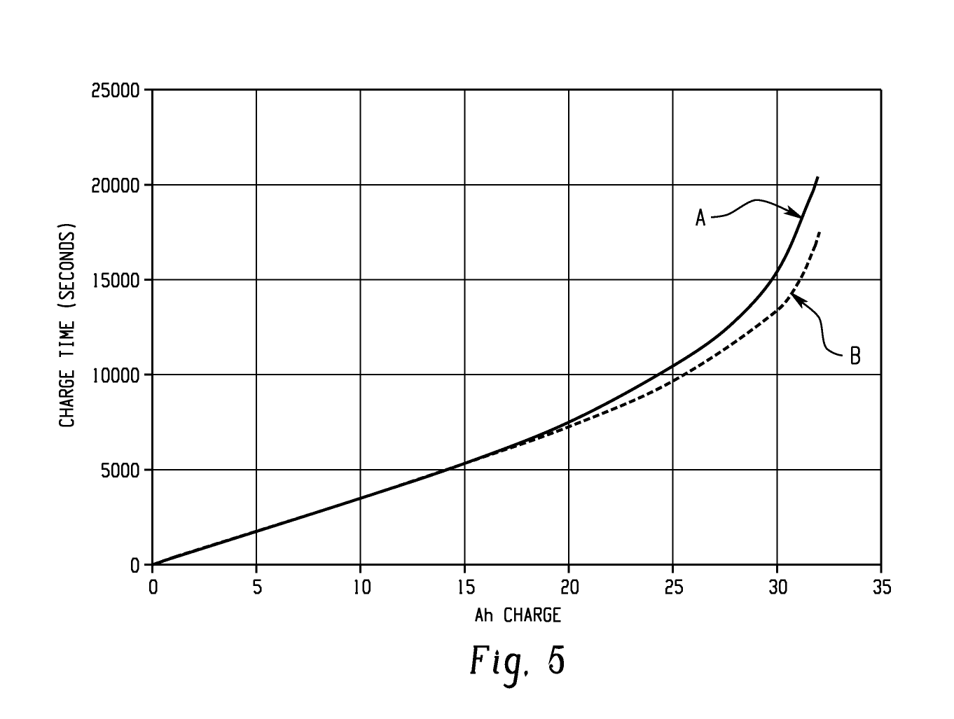

FIG. 5 provides charge performance data collected during the performance testing just described. As shown in FIG. 5, the data illustrates that Module B including Test Cells (B) with the molten salt reservoir (containing an additional 15 grams of molten salt electrolyte as compared to the amount included in Reference Cells A) recharged 32 Ah in 17,402 seconds, while Module A including the Reference Cells (A) (lacking a reservoir or other source of additional molten salt electrolyte) took 20,659 seconds to recharge 32 Ah, using the same charge regime as that used for cell B. This data shows that the presence of excess molten salt electrolyte, contained within an internal reservoir, enhances cell charge performance.

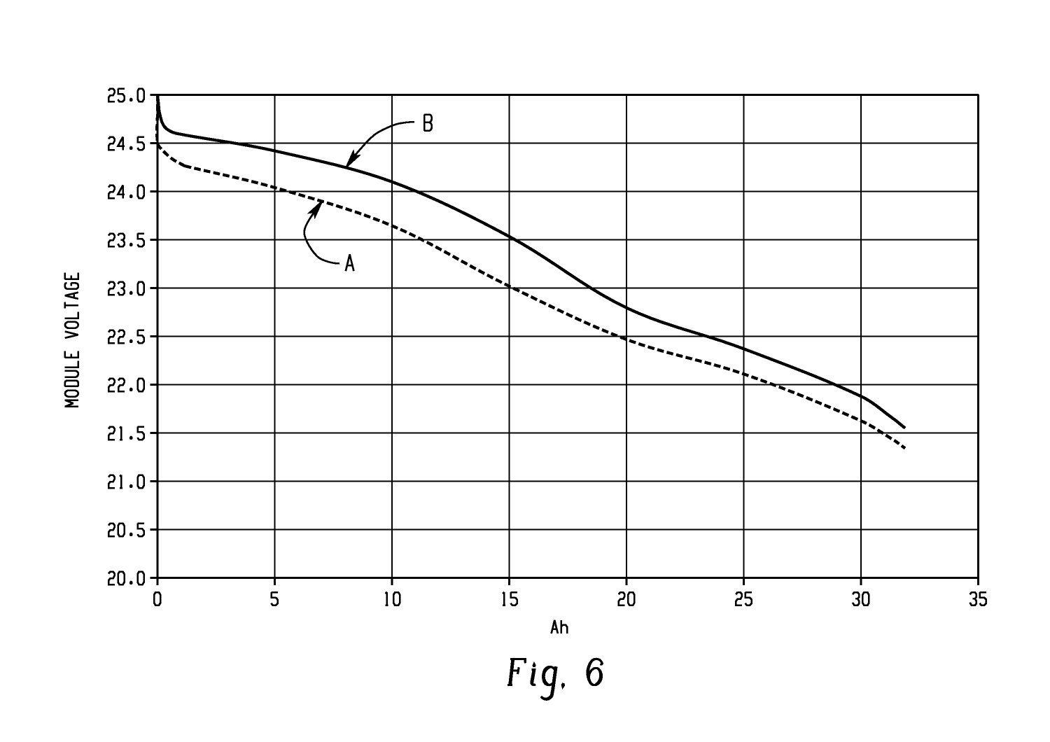

FIG. 6 provides discharge performance data for the two cell designs, A and B. The data indicates that the discharge of Module B containing the Test Cells (B) was at a higher voltage and the module delivered more energy to 32 Ah discharge, as compared to Module A containing the Reference Cells (A). Consistent with the charge performance data, the inclusion of the reservoir containing excess molten salt electrolyte is shown to enhance discharge performance of the cell.

### EXAMPLE 2

For this Example, Reference Cell C was prepared in the same manner as Cell A in Example 1, but having larger physical dimensions and configuration, and following the same steps. Cell C has a nickel metal current collector in the form of two lengths of 4 mm diameter nickel wire disposed within the cell. Cell C contained 1274 grams of positive electrode material fully impregnated with 567 grams of molten salt electrolyte, i.e. the level of molten salt electrolyte was at least as much as or exceeded the solid electrode material level in the positive electrode chamber or second region.

Test Cell D was prepared in the same manner as Reference Cell C, except Test Cell D includes a current collector that is a hollow nickel tube as opposed to nickel wire as used in Cell C. The hollow nickel tube is 20 millimeters in diameter. The Test Cell (D) is filled with 1250 grams of positive electrode material fully impregnated with 640 grams of molten salt electrolyte. The hollow nickel tube is disposed within the cathode in a coaxial, concentric manner. Excess molten salt, in an amount of approximately 94 cubic centimeters, was contained within the hollow nickel tube current collector and wicked into the positive electrode as space was generated during charging.

TABLE II

| | | | | | excess | |
|---|---|---|---|---|---|---|
| | | wt. (g) | | free | vol. of | |
| | wt. of | molten | | space | molten salt | vol. |
| | active | salt in | charge | created | in reservoir | reser- |
| Cell | material | cathode | (Ah) | (cm³) | membrance | voir |
| Refer- | 1274 g | 567 g | 215 Ah | 96.9 cm³ | — | — |
| ence | | | | | | |
| C | | | | | | |
| Test D | 1250 g. | 640 g | 211 Ah | 94 cm³ | 94 cm³ | 94 cm³ |

Reference Cell C, on its initial charge, gave 215 Ah of capacity, thus creating 96.9 cubic centimeters of void space in the positive electrode. As noted above, each Ah of charge creates 0.45 cubic centimeters of space in the chamber as the product of charge, i.e. nickel chloride has a smaller volume than the two reactants, nickel and sodium chloride. Test Cell D, on its initial charge, gave 211 Ah of capacity and created 94 cubic centimeters of space in the chamber. The 20 mm diameter hollow nickel tube current collector has an internal volume of 94 cubic centimeters which is filled with molten salt electrolyte on assembly. Thus, as space is created within the annular cathode second region of the device during charge, the molten salt flows from within the reservoir into the electrode to fill the voids created by the reaction of the materials. On discharge, the reservoir refills with molten salt as nickel chloride is converted to nickel and sodium chloride and the positive electrode solid volume increases.

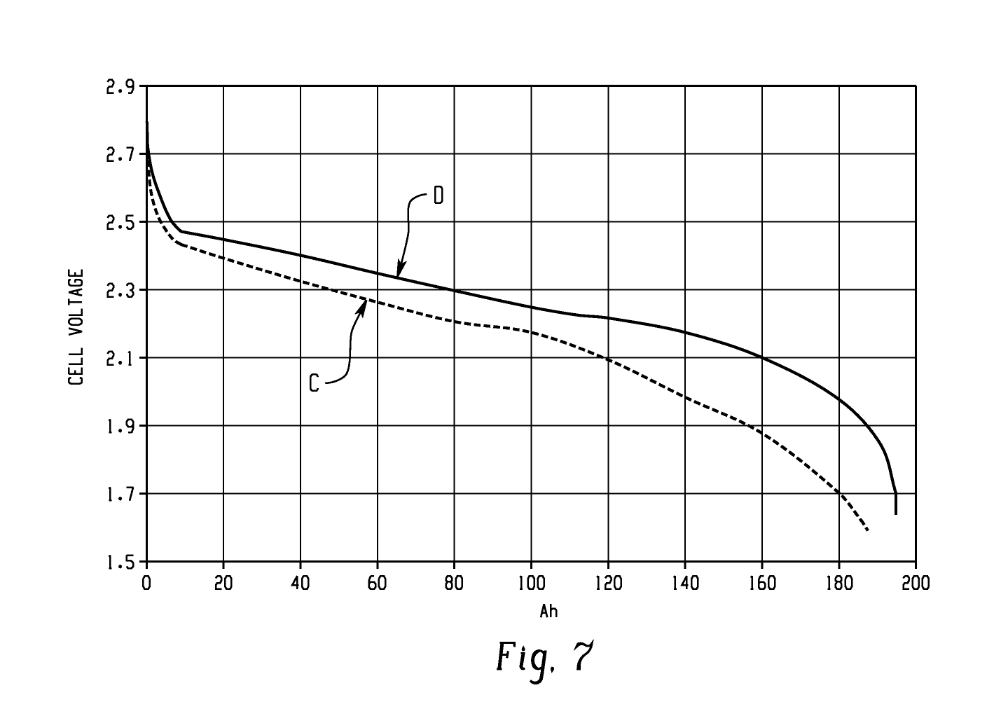

FIG. 7 is a comparison of discharge data collected for Reference Cell C and Test Cell D, both tested in an identical manner at 20 Amps. Test Cell D, including the novel hollow nickel tube central molten salt electrolyte reservoir, shows an improved working voltage over Reference Cell C throughout the discharge cycle.

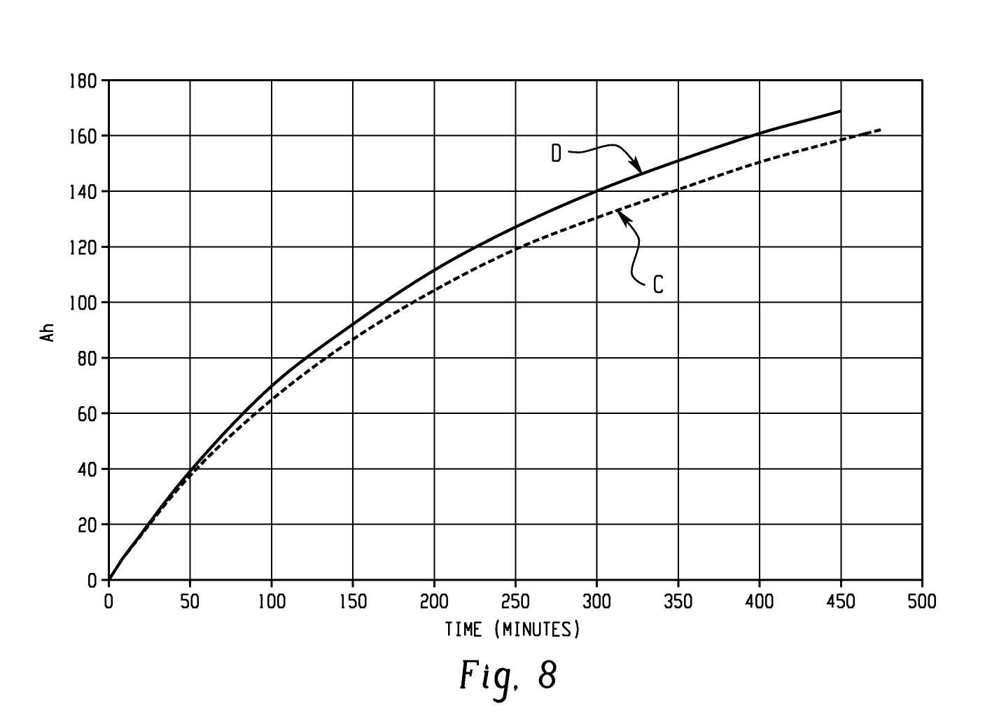

Another advantage of using the melt reservoir cell design, as used in Test Cell (D), is realized with regard to charging performance. The charge time of the Test Cell (D) having the novel hollow nickel tube central melt reservoir cell design is significantly reduced as compared to that of Reference Cell (C). This may be seen in FIG. 8, which provides a comparison of the charge time versus amp hours charge for each of Cells C and D charged at a constant voltage (2.8 V/50 Amp maximum Reference Cell C takes 450 minutes to charge 160Ah.

In a conventional sodium metal chloride cell assembled in the discharge state, the electrode is fully impregnated only in the fully discharged state. As the cell is charged, space is created in the positive electrode. This means that the performance of the top part of the electrode will be less than optimum because it is not fully flooded, leaving ionic conductor sites of the separator without active electrode material contact, i.e. no ions are being transported between the cathode and anode. However, with use of the novel melt reservoir presented herein positioned in operative communication with the positive electrode, the problem of under-performance is overcome, and the charge and discharge performance are improved, as shown in the Examples. The improvement is manifest in faster charge time and superior discharge of energy.

In addition, the central reservoir disclosed herein creates a thinner positive electrode, enhancing improvement of the charge and discharge performance of the device.

Whenever a particular feature of the invention is said to comprise or consist of at least one of a number of elements of a group and combinations thereof, it is understood that the feature may comprise or consist of any of the elements of the group, either individually or in combination with any of the other elements of that group.

Approximating language, as used herein throughout the specification and claims, may be applied to modify any quantitative representations that could permissibly vary without resulting in a change in the basic function to which it is related. Accordingly, a value modified by a term or terms, such as “about”, is not limited to the precise value specified. In some instances, the approximating language may correspond to the precision of an instrument for measuring the value. Similarly, “free” may be used in combination with a term, and may include an insubstantial number, or trace amounts, while still being considered free of the modified terms. The singular forms “a”, “and”, and “the” include plural reference unless the context clearly dictates otherwise. “Optional” or “optionally” means that the subsequently described event or circumstance may or may not occur, and that the description includes instances where the event occurs and instances where it does not.

The invention has been described with reference to the preferred embodiments. Obviously, modifications and alterations will occur to others upon reading and understanding the preceding detailed description. It is intended that the invention be construed as including all such modifications and alterations.

What is claimed is:

1. An energy storage device, comprising:
a housing having an inward facing surface defining a first region;
an ion-conducting member disposed within the first region, and the ion-conducting member having an inward facing surface defining a second region, and the second region is disposed within the first region;
a reservoir region that is a portion of the second region and is in operative communication with a second portion of the second region, and
the energy storage device having a plurality of operating states, and in a fully discharged operating state the reservoir region defines a volume at least equal to the volume of void space in the second region when the device is in a fully charged operating state.

2. The energy storage device of claim 1, wherein the reservoir region contains molten salt electrolyte and the plurality of operating states further includes operating states that are partially charged, and at a given operating state the reservoir region is correspondingly partially full with molten salt electrolyte.

3. The energy storage device of claim 1, further comprising a current collector, and the reservoir region is further defined by an inward facing surface of the current collector.

4. The energy storage device of claim 1, wherein the second region includes an active electrode material impregnated with a first portion of an electrolyte.

5. The energy storage device of claim 4, wherein the reservoir region includes a second portion of electrolyte equal to the volume of the reservoir region.

6. The energy storage device of claim 5, wherein at least some of the second portion of electrolyte is contained in a porous membrane material disposed in the second region.

7. The energy storage device of claim 1, wherein the second region includes active electrode material comprising a metal halide of the formula TX, and a molten salt liquid electrolyte of the formula MAlX₄, wherein
T is Ni, Fe, Cr, Co, Mn, Cu, or a mixture of two or more thereof;
X is Cl, Br, I, or a mixture of two or more thereof; and
M is Na, Li, or K, or a mixture of two or more thereof.

8. The energy storage device of claim 1, wherein the ion conducting member is a beta alumina separator and the reservoir region is defined by a hollow nickel tube current collector, and the hollow nickel tube current collector is sealed at an upper end and includes a path disposed to allow molten salt electrolyte contained within the hollow nickel tube current collector to transgress into the second region without allowing positive electrode material contained within the second region to transgress into the reservoir region.

9. The energy storage device of claim 1, wherein the ion conducting member is a beta-alumina tube disposed within the housing such that the first region is present between the housing and the beta-alumina tube; and a hollow nickel tube disposed within the beta-alumina tube creates the second region between the beta-alumina tube and the hollow nickel tube; and a reservoir region is present within the hollow nickel tube.

10. An energy storage device in accord with claim 9, wherein the beta-alumina tube has a diameter in a range of from about 30 millimeters to about 65 millimeters, an axial length in a range of from about 200 millimeters to about 500 millimeters, and a volume of about 140 cubic centimeters to 1658 cubic centimeters.

11. An energy storage device in accord with claim 10, wherein the hollow nickel tube has a diameter of about 10 millimeters to about 35 millimeters, an axial length of about 200 millimeters to about 500 millimeters, and a volume of about 16 cubic centimeters to about 480 cubic centimeters.

12. An energy storage device in accord with claim 11, wherein the second region has a width of about 13 millimeters.

13. The energy storage device of claim 1, wherein the first region defines an anode, the second region defines a cathode, and reservoir region is disposed within the cathode, such that the first, second and reservoir regions are arranged concentrically with the reservoir at the center and the anode farthest from the center.

14. A method for maintaining a fully flooded positive electrode during operation of an energy storage device, the method comprising:
providing a device having a first outermost region proximate a negative electrode, a central reservoir region, and a second region disposed intermediate the first region and the reservoir region and proximate a positive electrode;
flowing ionic mass from the second region to the first region, thereby creating a void space in the second region, and flowing molten salt from the reservoir region into the second region in response to the creation of the void space, thereby maintaining a fully flooded positive electrode during operation of the energy storage device.

15. The method of claim 14, further comprising flowing ionic mass from the first region to the second region.

16. The method of claim 14, wherein the reservoir region is defined by a current collector, and the molten salt comprises sodium chloroaluminate.

17. A system comprising an energizable device capable of being powered from an energy storage cell and operatively engaged with the energy storage cell, the energy storage cell comprising at least one anode/cathode electrode pair sharing an ion path, a current collector defining a reservoir disposed within the cathode, and a source of electrolyte disposed in the reservoir, the reservoir in operative communication with the cathode.

18. The system of claim 17, wherein the ion path is an ion conducting separator and the current collector is a hollow metal tube.

19. The system of claim 17, wherein the source of electrolyte disposed in the reservoir is molten salt liquid electrolyte and it is in addition to molten salt liquid electrolyte disposed in the cathode.

20. The system of claim 17, wherein the anode, the cathode, and the reservoir are arranged concentrically with the reservoir at the center and the anode furthest from the center.
